(19) United States
(12) Patent Application Publication
(10) Pub. No.: US 2010/0062127 A1
(43) Pub. Date: Mar. 11, 2010

(54) CUP WITH STATIC MIXER AND METHOD FOR PREPARATION OF A LIQUID PRODUCT

(75) Inventors: Cornelis Margaretha Theodorus Maria Bongers, Helmond (NL); Wiebe Nicolaas Van Druten, Zeewolde (NL)

Correspondence Address: SUGHRUE MION, PLLC, 2100 PENNSYLVANIA AVENUE, N.W., SUITE 800, WASHINGTON, DC, 20037, US

(73) Assignee: Friesland Brands B.V., Meppel (NL)

(21) Appl. No.: 12/516,430

(22) PCT Filed: Dec. 3, 2007
(86) PCT No.: PCT/NL2007/050615

§ 371 Date: Jul. 27, 2009

(30) Foreign Application Priority Data
Dec. 22, 2006 (NL) 2000401

(51) Int. Cl. A47J 31/40; A23L 2/52; B29C 67/20; A47J 31/44

(52) U.S. Cl. 426/431; 264/239; 99/295; 99/323

(57) ABSTRACT

Cup for the preparation of a liquid product, having a first chamber part (25) for holding a preparation substance, an inlet opening provided with a covering layer (16) with liquid-permeable perforations (17, 18, 19) for receiving a liquid suitable for the preparation substance, an outlet opening (24) for discharging the prepared beverage or dish, and a static mixer (5) which is in liquid communication with the outlet opening (24). The static mixer (5) is a multi-step mixer.

### FIELD OF THE INVENTION

The present invention relates to a cup for the preparation of a liquid product, such as a beverage or dish, by means of a preparation machine, comprising a first chamber part for holding a preparation substance, an inlet opening provided with a covering layer with liquid-permeable perforations for receiving a liquid suitable for the preparation substance, an outlet opening for discharging the prepared beverage or dish, and a static mixer which is in liquid communication with the outlet opening.

### PRIOR ART

Cartridges for use in the preparation of hot beverages based on a liquid concentrate are known, inter alia from WO-A-01/58786, EP-A-0 449 533, EP-A-1 101 430, WO-A1-03/073896, WO-A1-03/053200, WO-A1-02/19875, U.S. Pat. No. 6,130,990, U.S. Pat. No. 4,886,674, EP-A-1 440 907 and EP-A-1 440 908.

WO-A-01/58786 and EP-A-0 449 533 disclose a cartridge in which hot water is conveyed through a pointed inflow opening on the underside of the cartridge by way of a ‘ring line’ containing distribution openings, and also by way of said distribution openings through a compartment containing a concentrate, the water diluting the concentrate to a beverage by means of turbulence, which beverage is then conveyed by means of a siphon to an outflow opening on the underside of the cartridge.

EP-A-1 101 430 discloses a stepped cartridge in which, inter alia, provisions are included for using a liquid concentrate (paras [0034] and [0035]). For use of this cartridge the wall of the cartridge is pierced, after which hot water is conveyed through the concentrate by way of the inflow opening(s) thus created, thereby diluting the concentrate to a beverage, said beverage leaving the cartridge by way of a likewise pierced outflow opening.

WO-A1-03/073896 discloses a cartridge in which the underside of the cartridge is provided with perforations and is covered with a foil, which foil has to be removed before use. This cartridge also is suitable for a liquid concentrate (p. 14, lines 3-8 and Claim 18), hot water being conveyed through the concentrate from an inflow opening on the upper side, thereby diluting the concentrate to form a beverage, said beverage leaving the cartridge by way of the preformed perforations on the underside.

WO-A1-03/053200 and WO-A1-02/19875 disclose cartridges made of a flexible material, which cartridges are suitable for, inter alia, a liquid concentrate (WO-A1-03/053200, p. 5, lines 19-21; WO-A1-02/19875, p. 19, lines 4-6) for use in a water heater, the cartridge being clamped in a cavity designed for it and being pierced by a hollow needle, after which the water is conveyed through the concentrate to the outflow opening.

U.S. Pat. No. 6,130,990 discloses a water heater which is suitable for preparing a beverage based on concentrate in a cartridge (col. 5, lines 54-67; col. 7, lines 58-61; col. 9, line 66-col. 10, line 6).

U.S. Pat. No. 4,886,674 discloses a cartridge made of a flexible material, which cartridge is suitable for, inter alia, a liquid concentrate, the water supply being conveyed by way of a connection point through the concentrate to an outflow opening, which outflow opening is created by a weakened sealing seam, which sealing seam is opened by the working pressure of the machine.

European patent applications EP-A-1 440 907 and EP-A-1 440 908 disclose a cartridge for use in the preparation of beverages. This cartridge is dome-shaped and is sealed on the underside by means of a foil, and on the foil side is provided with both an inlet opening (on the edge) and an outlet opening (in the middle). Water (hot water) is conveyed by way of a pointed inflow opening on the underside of the cartridge and by way of a ‘ring line’ containing distribution openings against the sealing foil, and also by way of said distribution openings through a compartment. The compartment contains a concentrate, and the water dilutes the concentrate to a beverage by means of turbulence, which beverage is then conveyed by way of a siphon to an outflow opening on the underside of the cartridge. Special measures are also in place in the cartridge to ensure that the water runs evenly from the inlet opening in a radially inwardly directed manner through the interior space of the cartridge.

In a further embodiment EP-A-1 440 907 discloses a method for controlling the mixing of the water with the concentrate by means of provisions which delay the mixing of the concentrate with the water. In this case this provision is in the form of a sort of plate, the concentrate being added to the flow path of the water in a delayed manner through the holes on the underside of the plate.

None of the cartridges discussed above can be used in a water heater suitable for extraction pads made of filter material, so that it is necessary to use a preparation machine specially designed for these respective cartridge types. In particular, the connection of the inflow point on the cartridges means that water heaters that are suitable for extraction pads made of filter material are unsuitable for the abovementioned cartridges.

It is pointed out that a cup such as that referred to in the preamble above is disclosed in non pre-published patent application PCT/NL2006/050144.

### SUMMARY OF THE INVENTION

The aim of the present invention is to provide an improved cup or cartridge for the preparation in particular of hot products such as a chocolate beverage, in which a well-mixed product can be supplied.

To this end, according to the present invention, a cup of the type mentioned in the preamble is provided, in which the static mixer is a multi-step mixer. Multi-step turbulence generation can be provided, for example, in the static mixer, with the result that a better ready product is produced. Multi-step in this context means that the mix of liquid and preparation substance is mixed at more than one place in the flow from inlet opening of the cup to the outflow opening, for example by producing turbulence.

In one embodiment the static mixer is substantially cylindrical, is placed centrally in the cup, and is provided with at least one first opening to the first chamber part. This at least one first opening is advantageously provided where the radius of the conical shape is the smallest. The static mixer is therefore situated downstream of the first chamber part and is connected to the latter by means of the at least one first opening.

In a further embodiment the at least one first opening is provided with a seal which is opened under working pressure. In this way preparation substance in the chamber part can be prevented from passing into the static mixer before it is ready for use.

In one embodiment the static mixer comprises at least one second chamber part which can be filled with a preparation substance, and at least one riser channel and an outlet channel which is connected to the at least one riser channel and opens into the outlet opening of the cup, at least one second opening from each of the at least one second chamber parts to one or more of the at least one riser channels being present. In this way a multi-step generation of turbulence is produced in the static mixer, so that a much better mixing result is obtained.

In a further embodiment the at least one second chamber part is provided with a retardation means for the preparation. Said retardation means can be formed by, for example, a wax-like substance which melts slowly under the influence of the hot liquid. This can be used for, for example, a two-phase preparation, in which coffee is prepared first and a frothing milk layer is then prepared.

In a further embodiment the at least one second chamber part and the at least one riser channel are formed concentrically around the outlet channel. This simplifies the production of the cup. This effect is further reinforced in yet a further embodiment, in which walls between the at least one second chamber part and the at least one riser channel extend radially from a central axis of the cup.

In one embodiment the first opening is situated between the first chamber part and the at least one second chamber and consists of several partial openings. At least one partial opening can be placed within a predetermined angle of a wall between a riser channel and an adjacent second chamber part. This means that the flow from the first chamber part is, as it were, sucked along on the underside of the second chamber part to one of the adjacent riser channels.

In one embodiment a liquid communication is formed between the at least one riser channel and the outlet channel formed by a third opening in a wall of the static mixer. This adds an additional turbulence generation to the static mixer, with the result that its efficiency is improved even further.

In a further aspect the present invention relates to a method for preparation of a product by means of a cup filled with a preparation substance (for example a concentrate), the method comprising supplying a liquid (for example, hot water) to an upper side of the cup, the liquid and preparation substance being mixed by means of a static mixer in the cup, and comprising discharging a ready product from an underside of the cup. The static mixer is equipped for multi-step turbulence generation in the flow path in the cup. This is achieved by three different types of openings in the labyrinthine flow path in the static mixer, from the first chamber part to the second chamber part, from the second chamber part to the riser channel, and from riser channel to the outlet channel.

In a further embodiment the static mixer is provided with one or more second chamber parts which can be filled with a preparation substance, and the static mixer is equipped to utilize a venturi effect to entrain the preparation substance and preparation liquid from the first chamber part and the second chamber parts. The efficiency of product preparation is improved by this venturi effect. In other words, less preparation substance per cup is needed to obtain the same strength of product.

In yet a further aspect the present invention relates to the use of a cup according to an embodiment of the present invention in a preparation machine which is provided with an accommodation space for accommodating the cup, the preparation machine being equipped to convey heated water through the cup by way of the perforated covering layer of the cup.

The present invention also relates to a method for producing a cup according to one of the abovementioned embodiments, in which method the cup is formed in a single moulding step. Through this single moulding step, the cup is inherently easy to sterilize, for example with hydrogen peroxide, peracid etc. and is therefore extremely well suited for aseptic filling.

In an alternative method the cup is formed by combining a first part and a second part, the first part comprising at least the shell, and the second part comprising at least the static mixer. The two parts can subsequently be combined, for example by adhesion techniques which are known per se. In total, this alternative can result in more efficient and cheaper production of the cup.

### BRIEF DESCRIPTION OF THE DRAWINGS

The present invention will now be discussed in more detail on the basis of a number of exemplary embodiments, with reference to the appended drawings, in which:

FIG. 1 shows a cross-sectional view of a cup according to one embodiment of the present invention;

FIG. 2 shows a cross-sectional view in perspective of the cup according to FIG. 1;

FIG. 3 shows a top view of the cup according to FIG. 1 without the covering layer;

FIG. 4 shows a bottom view of the cup according to FIG. 1 without seal; and

FIG. 5 shows a cross-sectional view in perspective of the cup according to FIG. 1, viewed from the underside.

### DETAILED DESCRIPTION

With the cup 10 according to the present invention and an accompanying holder it is possible to prepare hot beverages such as, for example, hot chocolate with a preparation machine. To this end, the cup (also known as a cartridge or reservoir) is filled with a concentrate, which by means of the machine is mixed with hot water and dispensed into a cup or mug. Other beverages or dishes can also be prepared on the basis of a concentrate or another preparation substance, milk products, fruit juices, sauces and desserts.

The preparation substance is a product that can be dissolved or suspended in a liquid, and can be a powder, a liquid (concentrated), a syrup, a gel or another similar type of product. If a powder is being used, said powder preferably does not contain any difficultly soluble or insoluble substances (such as certain proteins), so that good mixing with the hot water in the cup is ensured. It is possible, for example in the embodiment of the cup 10 with a number of chamber parts to be described later, to use combinations of preparation substances, even a combination of a concentrate and a powder.

The cup 10 can be used with different fillings in the same preparation machine, thus producing the possibility of preparing several types of products, such as hot and cold beverages, with one machine.

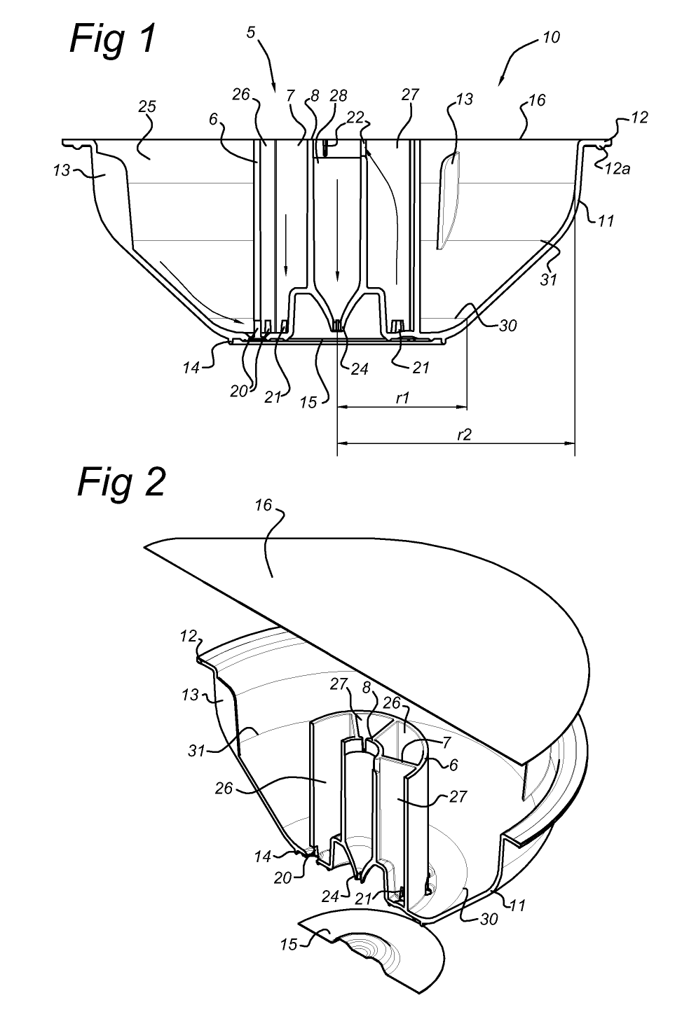

FIG. 1 shows a cross-sectional view of a cup 10 according to one embodiment of the present invention. FIG. 2 shows a cross-sectional view in perspective of the embodiment of FIG. 1. The cup 10 has a shell 11 with a rim 12 on the upper side. The rim 12 can furthermore be provided with a sealing edge 12a, which works together with a holder to provide a seal of the assembly of holder and cup 10, so that water is forced out of the machine through the cup 10. The sealing edge can also be provided as part of the holder or of the preparation machine.

The bowl-shaped underside 11 is furthermore provided with an edge 14. The bowl-shaped underside 11 is sealed inside the edge 14 by a seal 15 for transport and storage. The seal 15 is, for example, a plastic seal which is suitable for use in combination with foods.

The cup 10 is sealed on the upper side by a covering layer 16. The covering layer 16 can be a composite foil and can furthermore comprise, for example, a pull-off layer. The perforated covering layer 16 is, for example, made of a suitable plastic (for example, polypropylene), and the pull-off layer is made of another suitable material (for example, an aluminium-based foil). This means that a cup 10 filled with a preparation substance will keep well, the combination of covering layer and pull-off layer acting as a gas barrier and liquid barrier.

A static mixer 5 is present on the inside of the cup 10, which mixer can form part of the cup 10, which is produced in a single moulding step. This single moulding step means that the cup is inherently easy to sterilize with e.g. hydrogen peroxide, peracid etc, and is therefore extremely well suited for aseptic filling. Such a static mixer 5 contains no moving parts, which makes it simpler to produce and reliable in operation. Using a cup with a static mixer means that a well-mixed product can still be delivered, without any finishing operation (stirring in the cup) being necessary.

In an alternative method the cup 10 is formed by combining a first part and a second part, the first part comprising at least the shell 11, and the second part comprising at least the static mixer 5. The shell 11 can, for example, be deep-drawn, and the static mixer 5 can be produced by injection moulding. The shell 11 can, for example, be formed as a laminate of different materials, one layer of which comprises a liquid-resistant barrier and/or acid-resistant barrier. The two parts can then be combined, for example by adhesion techniques which are known per se. In total, this alternative can result in more efficient and cheaper production of the cup 10.

By means of a cylindrical wall 6 of the static mixer 5, a first chamber part 25 is formed on the inside of the cup 10, further bounded by the inside of the shell 11 and the covering layer 16, which first chamber part can be filled (partially) with a preparation substance. The inside of the shell 11 is conically shaped in a large part of the first chamber part 25. This means that between a first radius r1 and a second radius r2 measured from the centre point of the cup 10 (indicated by the lines 30 and 31 respectively on the inside of the shell 11) the inside follows a straight path. The height of the inside of the shell 11 (measured from the underside of the cup 10, for example the surface formed by edge 14) between the lines 30 and 31 runs directly proportionally to the radius from the centre of the cup 10. The part of the shell 11 between the lines 30 and 31 is a conical surface, which forms a predetermined angle with the upper side of the cup 10 (for example, indicated by the covering layer 16). The conical part of the inside of the shell 11 lies upstream of the static mixer 5.

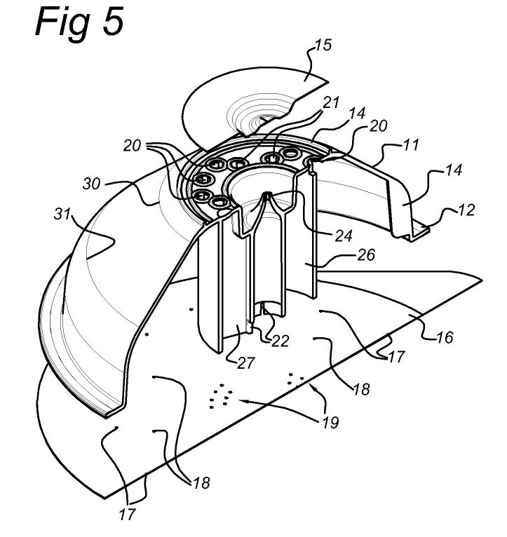

Surprisingly, it has been found that such a shape of the inside of the shell 11 leads to the liquid that is flowing through perforations (see FIG. 5 below) in the covering layer 16 into the cup being mixed well with the preparation substance in the first chamber part 25. Experiments have shown that no residues of any kind of the preparation substance are left behind in the cup 10.

The static mixer 5 in the embodiment shown comprises at least one second chamber part 26, in which—just as in the first chamber part 25—water flows down from the upper side of the cup 10 through covering layer 16, as indicated by the arrows. The cup 10 can also be filled with a preparation substance in the second chamber part 26. Furthermore, the static mixer 5 comprises at least one riser channel 27, in which water mixed with the preparation substance coming from the first chamber part 25 and the at least one second chamber part 26 flows back up again. The static mixer 5 also comprises an outlet channel 28, which is in liquid communication with an outflow opening 24 for discharging the finished product.

The outflow opening 24 is shaped in such a way that a prepared product can flow out directly into a cup or mug, without further contact with a part of the preparation machine. This means that no residues of prepared products are left behind in the preparation machine, with the result that cross-contamination between different products prepared one after the other is prevented. It also prevents the preparation machine from becoming soiled.

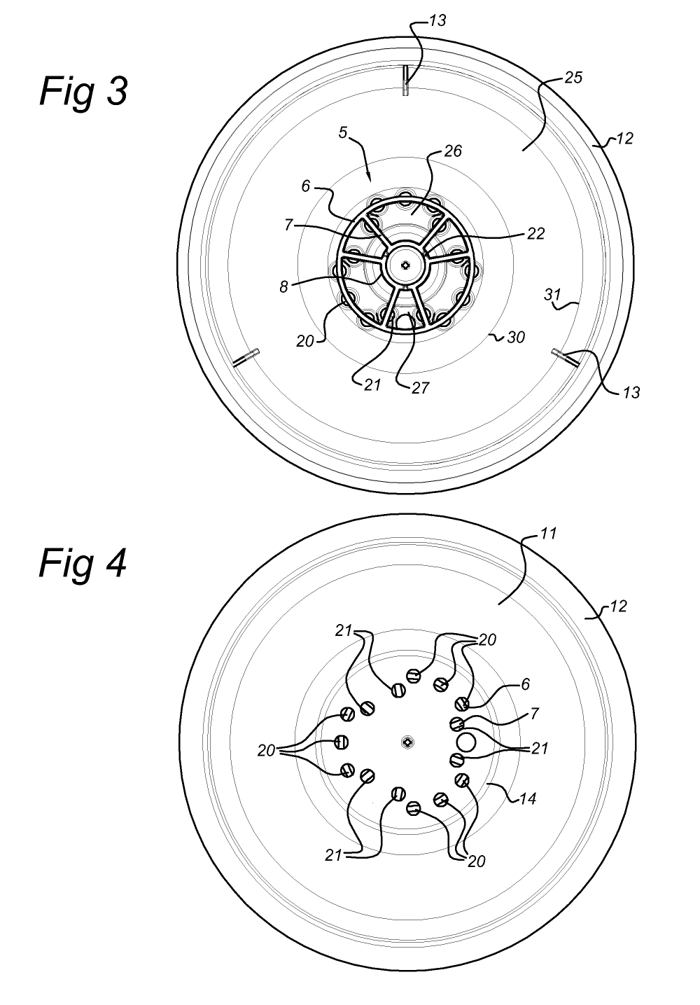

In the embodiment shown in FIG. 1 an orientation rib 13 is provided on the inside of the shell 11 for each second chamber part 26. This indicates in which area in the static mixer 5 a second chamber part 26 is located. The function of said rib is important for filling of the cup and the orientation of the covering layer 16, as is explained in greater detail with reference to FIGS. 3 and 5 below. In addition, the orientation ribs 13 ensure additional turbulence in the first chamber part 25, so that better mixing occurs. In an alternative embodiment additional ribs are provided, said additional ribs being placed in such a way that they cause additional turbulence, so that better mixing occurs.

A number of first openings 20 are provided between the first chamber part 25 and the second chamber part 26, at the edge where the static mixer 5 connects to the shell 11. A number of second openings are also provided between each second chamber part 26 and each riser channel 27, and a third opening 22 to the outlet channel 28 is provided for each riser channel. On the underside the second chamber parts 26 and riser channels 27 are sealed by the material of the shell 11. On the upper side the second chamber parts 26, riser channels 27 and outlet channel 28 are sealed by the covering layer 16.

The structure of the cup 10 with the abovementioned elements means that during use of the cup 10 a flow such as that indicated by the arrows inside the cup occurs in the cup 10. The combination of the elements ensures optimum flow and turbulence within the cup 10, with the result that good mixing of liquid and preparation substance can be achieved. The static mixer 5 according to this embodiment has multi-step turbulence generation, so that excellent mixing of liquid and preparation substance occurs. In this context multi-step means that the mix of liquid and preparation substance is mixed at more than one point in the flow from inlet opening of the cup 10 to the outflow opening 24, for example by making turbulence occur (for example, through the openings 20-22).

The first and second openings 20, 21 remain sealed by the seal 15 during use. The first, second and third openings 20-22 are formed directly in the parts of the cup 10 concerned during the production process of the cup 10, for example by an injection moulding process or a process using compression moulds. After filling of the cup, the various elements that are important for the flow inside the cup are formed by means of the seal 15 and covering layer 16.

The structure of the static mixer 5 is explained further with reference to the top view of the cup 10 shown in FIG. 3, the covering layer 16 not yet being present. The static mixer 5 is composed of two concentrically placed cylindrical walls 6 and 8. Together with radially directed walls 7, said cylindrical walls form the second chamber parts 26 and riser channels 27 of the static mixer. As shown in this embodiment, the static mixer comprises three second chamber parts 26 and three riser channels 27, adjoining each other in each case. In the top view it can also be seen that a third opening 22 to the outlet channel 28 is provided for each riser channel 27.

Since the second chamber parts 26 and riser channels 27 lie parallel to each other and the walls 6, 7, 8 run vertically, the production of the cup by means of an injection moulding process or compression moulding process is very simple.

As shown in the perspective view of FIG. 2, the third opening 22 is of a narrow, slightly elongated shape. This promotes additional turbulence in the flow of liquid mixed with preparation substance when said flow reaches the outlet channel 28.

This top view also shows that the orientation ribs 13 are provided at an angle from the centre (tangential angle) which corresponds to the centre of a second chamber part 26 in each case.

The first openings 20 and second openings 21 can be seen in FIG. 3, and can be seen more clearly in the bottom view of the cup 10 in FIG. 4 (in which the seal 15 has been removed for the sake of clarity). In the bottom view of FIG. 4 a part of the wall 6 of the static mixer 5 is visible in each case through the first openings 20, and a part of the radially directed wall 7 can be seen through the second openings 21 in each case.

In the embodiment shown it can be seen that from each second chamber part 26 a second opening 21 to both adjacent riser channels 27 is present. In an alternative, only a single second opening 21 to one of the two adjacent riser channels 27 could, for example, be provided for each second chamber part 26.

A group of first openings (or partial openings) 20 is provided in each case between the first chamber part 25 and each of the second chamber parts 26 present. In the embodiment shown each group of first openings 20 comprises three partial openings 20. It was found that placing an opening 20 in the centre of the second chamber part 26, combined with two openings 20 on the edge of the second chamber part 26 (close to the respective second openings 21) produces an extremely good mixing result (i.e. a homogeneous product and no residue left behind). In the exemplary embodiment shown, all first openings 20 are situated on a first circle, and the second openings 21 are situated on a second circle which is concentric with the first circle. Viewed from the centre, the first partial openings 20 on the outside of each second chamber part 26 lie within an angle of 35 degrees from the closest second opening 21. Good results are obtained when, as an alternative, three first openings 20 are placed in the wall 6, the central one being placed on the axis of the second chamber part 26 concerned. The other two first openings 20 can then be placed at an angle of 25 to 40 degrees relative to an axis of an adjacent riser channel 27, the optimum being found at 35 degrees. Since liquid flows (under some pressure) from the upper side of the cup 10 both into the first chamber part 25 and into the second chamber parts 26, a sort of venturi effect occurs at the first openings 20, with the result that liquid (mixed with preparation substance) is, as it were, entrained to the riser channel 27 by way of the second openings 21.

Alternative embodiments are possible, in which embodiments the number of first, second and third openings 20-22 is different, or in which the shape of the openings 20-22 is different. This can depend, for example, on the type of preparation substance and the properties of the preparation substance (e.g. viscosity, fibres, insoluble particles etc.).

FIG. 5 shows a cross-sectional view in perspective, more from the underside of the cup 10. In this FIG. 5 the perforations in the covering layer 16 are also shown. A first ring of perforations 17 and a second ring of perforations 18 lie above the first chamber part 25. Furthermore, a group of perforations 19 lies above each of the second chamber parts 26.

The proportion of the total surface area in perforations above the first chamber part 25 and the second chamber parts 26 is important for the flow arising inside the cup 10, since the liquid supply in the preparation machine is reasonably uniform. In one embodiment, which was found to work particularly well, a proportion of 40% of the perforations lay above the first chamber part 25 (in other words, a first number comprising the first and second ring of perforations 17, 18) and 60% above the second chamber parts 26 (in other words, a second number comprising the group of perforations 19). This has the advantage that the preparation substance in the second chamber parts 26 is the first to be, as it were, flushed through, after which the preparation substance in the first chamber part 25 follows more gently. Other proportions are, of course, possible, and depend upon the desired effect of dissolving or mixing of the liquid with the preparation substance(s).

It can be seen in FIG. 5 that the perforations in the perforated covering layer 16 are provided in a certain pattern. By changing the distribution of the perforations in the covering layer 16, it is possible to achieve a different flow pattern or flow ratio through the cup 10, which can lead to better mixing of the finished product. The flow pattern or flow ratio can also be adapted to product properties, such as the viscosity. In general, the covering layer 16 can be divided into two areas, a central part which is bounded by the static mixer 5, and a ring part lying outside that, which is situated directly above the first chamber part 25 of the cup 10. The central part is not fully provided with perforations, and since the covering layer 16 is fixed to the top edge of the static mixer 5, no liquid can flow out of the preparation machine directly into the riser channels 27 or the outlet channel 28.

As shown in the figures, the perforations in the perforated covering layer 16 can be formed by round holes. In an alternative, all perforations or, for example, only the perforations in a part of the perforated covering layer 16 can be of a different shape, for example elongated slits, cross cuts etc.

The groups of perforations 19 above the second chamber parts 26 do, of course, have to be precisely aligned during the production process. A marking on the outside of the cup 10 would make use of the cup in a preparation machine of the type described above more difficult. The orientation ribs 13 on the inside of the shell 11 provide a solution to this (see also FIG. 3 and the corresponding description above). During the filling of the second chamber parts 26 the filling machine can be oriented by means of the orientation ribs 13. These orientation ribs 13 can also be used for the fixing of the covering layer 16. A secondary effect is that the orientation ribs 13 give the cup additional strength, so that the shell 11 can be made thinner.

It has already been pointed out above that the shape of the inside of the shell 11 is conical, so that during the preparation of the product the preparation substance is more completely entrained from the first chamber part 25. This effect can be improved further by the correct distribution of the perforations in the covering layer 16 above the first chamber part 25. In the embodiment shown, a first ring of perforations 17 is provided at a greater distance from the centre of the cup 10, and a second ring of perforations 18 is provided at a slightly shorter distance from the centre. It has been found that positioning of these two rings of perforations 17, 18 above the bends in the profile of the shell 11 (i.e. at the level of the radii r1 and r2 shown in FIG. 1, or at the level of the rings 30, 31 shown in FIGS. 1, 2 and 5) has a particularly advantageous effect on the flow of liquid in the first chamber part 25. In a specific embodiment the radius r1 is 36 mm, and the radius r2 is 50 mm. The turbulences arising through the liquid being forced through the relatively small perforations are influenced in the first chamber part 25 by the mixing with the preparation substance in such a way that the entire first chamber part 25 is, as it were, cleaned out.

The cup 10 according to the present invention can be used for preparation of a product based on liquid and one type of preparation substance. Both the first chamber part 25 and all second chamber parts 26 present are then partially filled with the same preparation substance.

In further embodiments of the cup it is, however, also possible to use more than one type of preparation substance. For example, the second chamber parts 26 can be filled with a first preparation substance, and the first chamber part 25 can be filled with a further preparation substance. As described above, the second chamber parts 26 are substantially flushed out first, after which the first chamber part 25 is flushed out. This is useful for preparing various types of combined products, even those where two or more different preparation substances are used one after the other. An example is the preparation of cappuccino, where coffee is made first and a milk froth layer is then made. In a further alternative the various second chamber parts 26 can also be filled with different preparation substances (for example, additional flavourings). In yet a further embodiment the first chamber part 25 can be compartmentalized, each compartment being filled with a different preparation substance.

The sequence in which the preparation substances in the first chamber part 25 and the second chamber parts 26 are dissolved in the pressurized liquid depends on the distribution and number of perforations above the part of the covering layer 16 concerned. In a further embodiment a retardation measure can be provided in one or more of the second chamber parts 26 (or even in the first chamber part 25) by placing a wax-like product which is virtually odourless and tasteless on top of the preparation substance. In operation, it will take some time before this wax-like product has melted, after which only the liquid can penetrate into the appropriate preparation substance.

As an alternative, it is also possible for the first openings 20 on the underside of the cup to be provided in such a way that said openings can be sealed with the seal 15, for example by making the walls 6 at the position of the openings 20 run on through parallel to the underside of the shell 11. By making the seal 15 a weak seal, i.e. with less adhesion than the remainder of the seal, at the position of the openings 20, it is ensured that the opening 20 can be cleared by the working pressure of the liquid in the cup 10 (caused by the preparation machine). During transport and storage it is then guaranteed that the preparation substances in the first chamber part 25 and the second chamber parts 26 remain separate.

The invention is explained in the above description on the basis of a number of embodiments with reference to the appended drawings. However, the scope of protection of this application also extends to possible changes and modifications which fall within the definitions of the terms used in the claims. For example, the shape of the cup is shown as circular, but it will be clear to the person skilled in the art that other shapes (square, inverted pyramid shape, oval) can also be used.

1. Cup for the preparation of a liquid product, comprising a first chamber part (25) for holding a preparation substance, an inlet opening provided with a covering layer (16) with liquid-permeable perforations (17, 18, 19) for receiving a liquid suitable for the preparation substance, an outlet opening (24) for discharging the prepared beverage or dish, and a static mixer (5) which is in liquid communication with the outlet opening (24), in which the static mixer (5) is a multi-step mixer situated downstream of the first chamber part (25), and arranged to mix at more than one point in the flow,
in which the static mixer (5) comprises two concentrically placed walls (6, 8) and radially directed walls (7) in between the two concentrically placed walls (6, 8), which form at least one second chamber part (26) which can be filled with a preparation substance, at least one riser channel (27), and an outlet channel (28) which is connected to the at least one riser channel (27) and opens into the outlet opening (24) of the cup (10), at least one second opening (21) being provided from each of the at least one second chamber parts (26) to one or more of the at least one riser channels (27) being present.

2. Cup according to Claim 1, in which the static mixer (5) is substantially cylindrical, is placed centrally in the cup (10), and is provided with at least one first opening (20) to the first chamber part (25).

3. Cup according to Claim 2, in which the at least one first opening (20) is provided with a seal which is opened under working pressure.

4. Cup according to claim 1, in which the at least one second chamber part (26) is provided with a retardation means for the preparation.

5. Cup according to claim 1, in which the at least one second chamber part (26) and the at least one riser channel (27) are concentrically formed around the outlet channel (28).

6. Cup according to claim 1, in which the walls (7) between the at least one second chamber part (26) and the at least one riser channel (27) extend radially from a central axis of the cup (10).

7. Cup according to claim 1, in which the first opening (20) is situated between the first chamber part (25) and the at least one second chamber part (26) and consists of a number of partial openings (20).

8. Cup according to claim 7, in which at least one partial opening (20) is placed within a predetermined angle of a wall (7) between a riser channel (27) and an adjacent second chamber part (26).

9. Cup according to claim 1, in which a liquid communication between the at least one riser channel (27) and the outlet channel (28) is formed by a third opening (22) in a wall of the static mixer (5).

10. Method for preparation of a product by means of a cup (10) filled with a preparation substance, the method comprising:
supplying a liquid to an upper side of the cup (10), the liquid and preparation substance being mixed by means of a static mixer (5) in the cup (10), and discharging a ready product from an underside of the cup (10),
in which the static mixer (5) is situated downstream of a first chamber part (25) holding the preparation substance and equipped for multi-step turbulence generation in the flow path in the cup (10),
in which the static mixer (5) comprises two concentrically placed walls (6, 8) and radially directed walls (7) in between the two concentrically placed walls (6, 8), which form at least one second chamber part (26) which can be filled with a preparation substance, at least one riser channel (27), and an outlet channel (28) which is connected to the at least one riser channel (27) and opens into the outlet opening (24) of the cup (10), at least one second opening (21) being provided from each of the at least one second chamber parts (26) to one or more of the at least one riser channels (27) being present.

11. Method according to claim 10, in which the static mixer (5) is provided with one or more second chamber parts (26) which can be filled with a preparation substance, and is equipped for utilizing a venturi effect to entrain the preparation substance and preparation liquid from the one or more second chamber parts (26).

12. Use of a cup according to claim 1, in a preparation machine which is provided with an accommodation space for accommodating the cup (10), the preparation machine being equipped to convey heated water through the cup (10) by way of the perforated covering layer (16) of the cup (10).

13. Method for producing a cup according to claim 1, in which the cup (10) is formed in a single moulding step.

14. Method according to claim 13, in which the cup (10) is sterilized prior to an aseptic filling step.

15. Method for producing a cup according to claim 1, in which the cup (10) is formed by combining a first part and a second part, the first part comprising at least the shell (11), and the second part comprising at least the static mixer (5).
